(19) United States
(12) Patent Application Publication
(10) Pub. No.: US 2017/0171299 A1
(43) Pub. Date: Jun. 15, 2017

(54) Method for Using a Device Serial Number to Select a Cloud Server

(71) Applicant: Wireless Input Technology, Inc., Wilmington, DE (US)

(72) Inventor: Gang Bi, Grayslake, IL (US)

(73) Assignee: Wireless Input Technology, Inc., Wilmington, DE (US)

(21) Appl. No.: 14/964,581

(22) Filed: Dec. 10, 2015

(51) Int. Cl. H04L 29/08; H04L 12/66; H04L 12/28; H04L 29/06

(52) U.S. Cl. CPC H04L 67/10; H04L 67/42; H04L 12/66; H04L 12/2803

(57) ABSTRACT

This invention discloses a method implemented on a cloud server which issues a unique device serial number to be assigned to a network device (e.g., a WPAN gateway, smart home device). Among other things, the unique device serial number contains a cloud server identification portion which uniquely identifies the issuing cloud server. When the network device is powered on, a identifies the cloud server based on the cloud server identification portion of its device serial number and tries to connect with the cloud server. Upon receiving such a connection on request, the cloud server checks whether the network device's device serial number was one it issued previously. If yes, the cloud server allows the connection. Otherwise, the cloud server denies the connection.

### FIELD OF INVENTION

This invention generally relates to issuing and using device serial numbers. More specifically, this invention relates to a method for issuing a device serial number to a network device so that the network device may use the device serial number to select a cloud server from a plurality of cloud servers for communication during its operation.

### BACKGROUND OF THE INVENTION

Home automation and security systems allow home owners to remotely monitor their homes, receive security alerts, and control the various devices and/or appliances connected by Wireless Personal Area Networks (WPANs) (e.g., Zigbee networks, Z-wave networks) from mobile devices (e.g., smartphones). Generally, a WPAN includes a gateway device which serves as a bridge between the WPAN and external networks and handles the data traffic coming into or going out of the WPAN. A gateway device and a mobile device may be configured to communicate with each other directly. However. such configuration is usually complicated and a thick client application is required on the mobile device. For a lot of users who are not technically sophisticated, this solution is simply too complicated.

An alternative solution is to provide an intermediate server between the mobile device and the gateway device. The intermediate server facilitates the communication between the mobile device and the gateway device. In this case, only a thin client application is required on the mobile device. The intermediate server provides functions to simplify the configuration of the gateway device and the mobile device. In addition, it can support a large number of such gateway devices and mobile devices—a cost effective solution for a service provider. Recently, with the development of cloud computing technologies, such an intermediate server may be deployed on a cloud server. This arrangement further reduces the cost and complexity of maintaining such an intermediate server by a service provider. To further improve service quality (such as speed), a service provider can. use a particular cloud server to serve a specific group of users within a geographical area. However, this mechanism requires users know which cloud server to choose when configuring their mobile devices and gateway devices. This may be difficult for users to handle. Thus, a new system is needed to facilitate such configuration.

### SUMMARY OF THE INVENTION

A cloud server issues a unique device serial number and stores the device serial number in a data repository for future reference. The device serial number is assigned to a network device during manufacture of the device. Among other things, the unique device serial number contains a cloud server identification portion which uniquely identifies the cloud server. When the network device is powered on, it communicates with a configuration server to receive network parameters of the cloud server it should be connecting with during its operation. The configuration server receives the device serial number from the network device, selects the cloud. server from a plurality of cloud servers based on the cloud server identification portion of the device serial number, retrieves the corresponding network parameters of the cloud server (e.g., IP address, port, number, login credentials), and sends the network parameters to the network device. The network device then uses the network parameters to send a registration or login request to the cloud server. The registration or login request also includes the device serial number of the network device. Upon receiving the registration or login request and the device serial number, the cloud server determines whether the device serial number was one it issued before. If so, the cloud server permits the registration or login and establish the connection with the network device. Otherwise, the cloud server rejects the registration or login request.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identities the drawing in which the reference number first appears.

FIG. 1 is a block diagram of a network system where the present invention may be implemented.

FIG. 2 is a diagram illustrating an exemplary structure of a device serial number.

FIG. 3 is a flow diagram illustrating a process of issuing a device serial number according to an embodiment of the present invention.

FIG. 4 is a block diagram of a network system where the present invention may be implemented.

FIG. 5 is a flow diagram illustrating a process of a network device's registration with or login to a cloud server according to an embodiment of the present invention.

FIG. 6 is a flow diagram illustrating a process of processing a network device's registration or login request according to an embodiment of the present invention.

### DETAILED DESCRIPTION

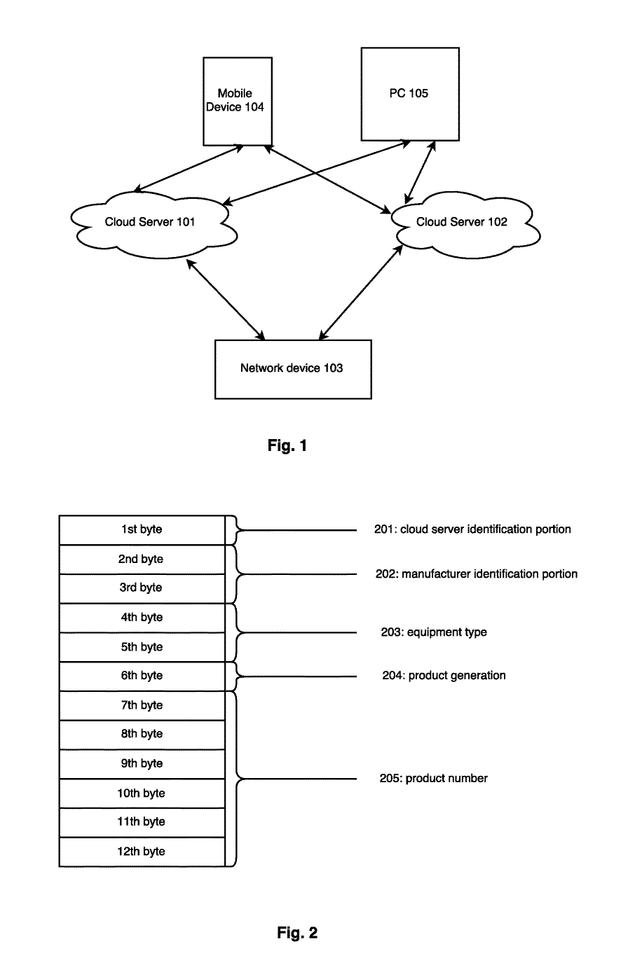

FIG. 1 is a block diagram of a network system where the present invention may be implemented. As shown in FIG. 1, a network device 103 can communicate with the mobile device 104 and the personal computer (“PC”) 105 via either the cloud server 101 or the cloud server 102. In one embodiment either the cloud server 101 or the cloud server 102 may issue a device serial number. The device serial number has a cloud server identification portion for identifying the particular cloud server that issued the device serial number. The device serial number may then be assigned to a network device (such as the network device 103 shown in FIG. 1) during manufacture. When the network device 103 is powered on, it determines which cloud server issued its device serial number based on the cloud server identification portion of its device serial number. Then, the network device 103 sends a registration or login request to connect with that particular cloud server. For example, the network device 103 may find out that its device serial number was issued by the cloud server 101 based an the cloud server identification portion of its device serial number. Then, it will try to connect with the cloud server 101 rather than the cloud server 102. It should be noted that more than two cloud servers may be used for implementation of the present invention although only two cloud servers are shown in FIG. 1.

In one embodiment the network device 103 is a gateway device of a WPAN. Other devices of the WPAN (not shown in FIG. 1) may communicate with the mobile device 104, the PC 105, or other external devices via the network device 103. For example, if a window magnetic sensor device detects the opening of the window to which the sensor device is attached, the sensor device sends a message to the network device 103, which in turn sends an alert message to the cloud server 101 regarding the opening of the window, assuming the network device 103 is connected with the cloud server 101. The cloud server 101 may push the alert message to the mobile device 104 to inform the user that the window at her home was just opened, assuming the mobile device 104 is configured to communicate with the network device 103.

FIG. 2 is a diagram illustrating an exemplary structure of a device serial number. As shown in FIG. 2, the device serial number includes a cloud server identification portion 201, a manufacturer identification portion 202, an equipment type portion 203, a product generation portion 204 and a product number portion 205. The device serial number is digitally represented by twelve (12) bytes. The first byte is used to represent the cloud server identification portion 201 or cloud server ID, which uniquely identifies the cloud server that issued this device serial number. For example, the first byte may contain the letter “A” to represent the cloud server 101 or the letter “B” to represent the cloud server 102. The second and third bytes are used to represent the manufacturer identification portion 202, or the manufacturer ID, which uniquely identities the manufacturer of a network device to which the device serial number is assigned. The fourth and fifth bytes are used to represent the equipment type portion 203, or equipment type ID, which uniquely identifies the equipment type of the device (e.g., gateway device, smart home product). The sixth byte is used to represent the product generation portion 204, or product generation ID, which uniquely identifies the product generation of the device. And the seventh through twelfth bytes are used to represent the product number portion 205. In one embodiment, the product number portion 205 is a random number generated by a random number generator.

It should be noted that the structure shown in FIG. 2 is an exemplary structure of a device serial number. In other embodiments, a device serial number may include more or fewer portions and may be represented by more or fewer digital bytes than those shown in FIG. 2.

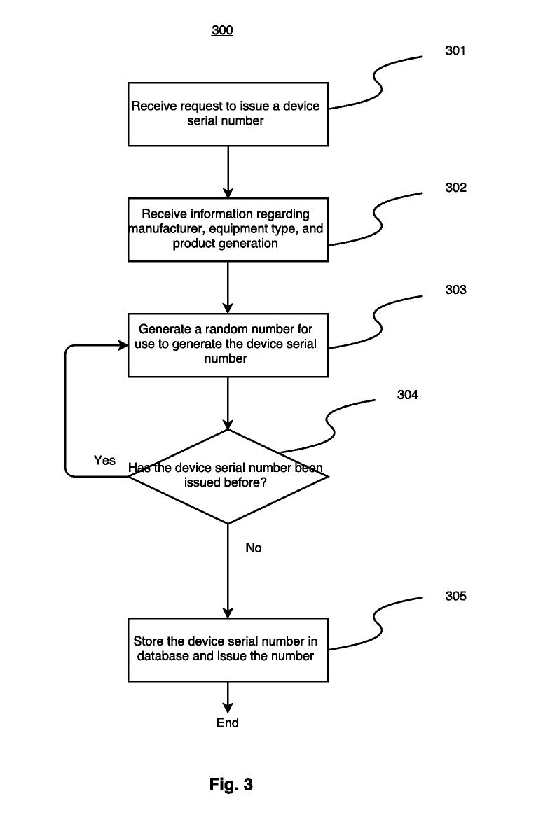

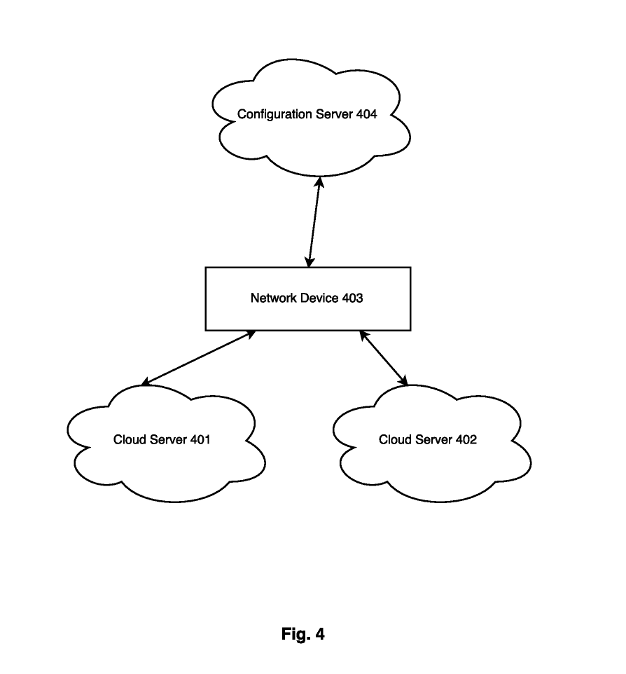

FIG. 3 is a flow diagram illustrating a process 300 of issuing a device serial number. The process 300 is executed by a processor of a cloud server (e.g., cloud server 101 or cloud server 102). And there can be multiple instances of the process 300 running simultaneously at any time to process multiple requests.

At step 301, the process 300 receives a request to issue a device serial number to be assigned to a network device. The request may be sent by a service provider in need of filling a customer order of a network device (e.g., a gateway device, a smart home device). In one embodiment, the service provider may send the request remotely from a mobile device or a PC.

At step 302, the process 300 receives information regarding manufacturer, equipment type, and product generation of the network device ordered by the customer. In one embodiment, such information comprises a manufacturer ID, an equipment type and a product generation ID.

At step 303, the process 300 generates a random number by, for example, calling a random number generator. In addition, the process 300 generates the device serial number based on the identification information of the cloud server, the information received at step 302, and the random number. For example, according to the exemplary structure shown in FIG. 2, the device serial number may be “AYCGW204ABE8,” where the first letter “A” identities the cloud server, the second and third letters “YC” identify the manufacturer of the network device to which the device serial number is assigned to, the fourth and fifth letters “GW” indicate that the device is a gateway device, the digit “2” following the letter “W” identifies the generation of the device, and the last six digits “04ABE8” is the hexadecimal representation of the random number.

At step 304, the process 300 determines whether the generated device serial number has been issued before by the cloud server. In one embodiment, the cloud server maintains a data repository storing all previously issued device serial numbers. The data repository may be a file or a database. The process 300 searches the data repository and determines whether the device serial number just generated matches any one of all previously issued device serial numbers. If yes, the process 300 goes back to step 303 to try again. If no, the process 300 goes to step 305, where it stores the device serial number in the data repository and issues the device serial number for use. After step 305, the process 300 ends.

As discussed above, a network device determines which cloud server to connect with based on the cloud server identification portion of its device serial number. The network device needs certain network parameters for connecting with the selected cloud server. Such network parameters may include, but are not limited to, the cloud server's IP address, port number, and login credentials (e.g. user ID and password). In one embodiment, such network parameters are stored on the network device. For example, such information may be hardcoded in a program or stored as a configuration file on the network device. However, after the network device has been sold to a customer, it would be difficult to update such network parameters if they change later. FIG. 4 shows an alternative solution that can overcome this difficulty. As shown, a configuration server 404 is provided to maintain network parameters for all cloud servers, including hut not limited to cloud server 401 and cloud server 402. The network device 403 sends its device serial number to the configuration server 404 to request network parameters of the cloud server which issued the device serial number. In response, the configuration server 404 searches its data repository and retrieves network parameters of the cloud server based on the cloud server identification portion of the device serial number and sends the network parameters to the network device 403. Thus, if the network parameters regarding any cloud server change, only the data repository of the configuration server 404 needs to be updated to reflect the change. No change is required on the numerous network devices which are or would be connecting with the particular cloud server.

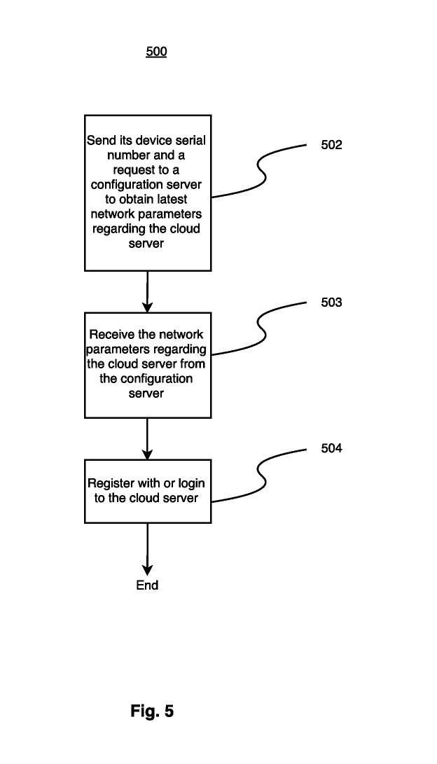

FIG. 5 is a flow diagram illustrating a process 500 of a network device's registration or login with a cloud server. The process 500 is executed by a processor of a network device (such as the network device 403 shown in FIG. 4).

At step 501, the process 500 sends the network device's serial number to a configuration server. Alternatively, the process 500 just sends the cloud server identification portion of its serial number (or the cloud server ID) to the configuration server.

At step 502, the process 500 receives the network parameters of the cloud server from the configuration server.

At step 503, the process 500 sends a login or registration request to the cloud server by using the network parameters.

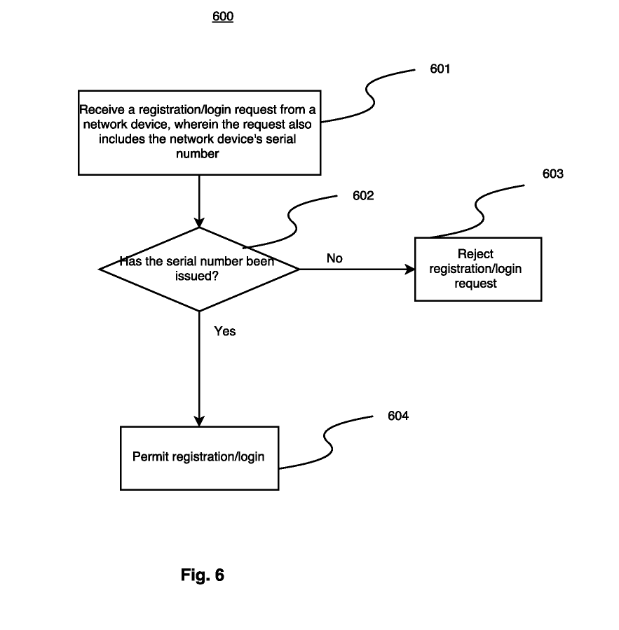

FIG. 6 is a flow diagram illustrating a process 600 of processing a network device's registration or login request. The process 600 is executed by a processor of a cloud server and there can be multiple instances of the process 600 running simultaneously at any time to process multiple requests.

At step 601, the process 600 receives a registration or login request from a network device. The request also includes the network device's serial number.

At step 602, the process 600 determines whether the device serial number has been issued by the cloud server. For example, as discussed above, the cloud server may maintain a data repository storing all previously issued device serial numbers. The process 600 searches the data repository and determines whether the device serial number matches any of the previously issued one. If the answer is yes, then the registration or login request is permitted at step 604. Otherwise, the requested is rejected at step 603.

With reference to FIG. 1 again, the mobile device 104 needs to connect with the cloud server 101 so that it can communicate with the network device 103, assuming the network device 103 is connected with the cloud server 101. In one embodiment, the mobile device 104 uses the device serial number of the network device 103 to connect with the cloud server 101 by following a process similar to the process 500. The mobile device 104 may receive the device serial number by sending a request to the network device 103 when they are in a same home network (e.g., a Wi-Fi network), scanning a barcode or QR code representation of the device serial number printed on the network device, or receiving it from a user input. Alter the mobile device 104 is connected with the cloud server 101 with the network device 103's device serial number, the cloud server 101 is able to facilitate the communication between the mobile device 104 and the network device 103.

It should be noted that any mobile device may be configured to communicate with one or more network device and any network device may be configured to communicate with one or more mobile device. The corresponding cloud server may maintain a configuration list mapping these relationships.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim.:

1. A method performed by a processor of a cloud server, the method comprising:
receiving a request for issuing a device serial number to be assigned to a network device that will use the device serial number to select the cloud server from a plurality of cloud servers and connect with the cloud server for operation;
receiving information regarding the network device;
generating the device serial number, wherein the device serial number has a cloud server identification portion, a device information portion, and a random number;
determining whether the device serial number has been issued previously; and
issuing the device serial number.

2. The method of claim 1, wherein the network device is a gateway device of a WPAN.

3. The method of claim 1, wherein said information regarding the network device comprises manufacturer information, equipment type, and product generation.

4. The method of claim 1, wherein the cloud server identification portion comprises a cloud server ID which uniquely identifies the cloud server.

5. The method of claim 1 further comprising storing the device serial number in a data repository.

6. The method of claim 1 further comprising:
receiving a connection request from a second network device;
receiving the second network device's device serial number;
determining whether the second network device's device serial number was one previously issued by the cloud server; and
allowing the connection request.

7. The method of claim 6, wherein the connection request is one of a registration request and login request.

8. A cloud server comprising:
a memory for storing instructions;
a data repository for persistently storing data; and
a processor which, upon executing the instructions, performs a process comprising:
receiving a request for issuing a device serial number to be assigned to a network device that will use the device serial number to select the cloud server from a plurality of cloud servers and connect with the cloud server for operation;
receiving information regarding the network device;
generating the device serial number, wherein the device serial number has a cloud server identification portion, a device information portion, and a random number;
determining whether the device serial number has been issued previously;
issuing the device serial number; and
storing the device serial number in the data repository.

9. The cloud server of claim 8, wherein the process further comprises:
receiving a connection request from a second network device;
receiving the second network device's device serial number;
determining that the second network device's device serial number was one previously issued by the cloud server; and
allowing the connection request.

10. The cloud server of claim 8, wherein the network device is a gateway device of a WPAN.

11. The cloud server of claim 8, wherein said information regarding the network device comprises manufacturer information, equipment type, and product generation.

12. The cloud server of claim 8, wherein the cloud server identification portion comprises a cloud server ID which uniquely identifies the cloud server.

13. The cloud server of claim 9, wherein the connection request is one of a registration request and login request.

14. A non-transient computer readable medium programmed with computer readable code that upon execution by a processor of a server causes the processor to:
receive a request for issuing a device serial number to be assigned to a network device that will use the device serial number to select the server from a plurality of servers and connect with the server for operation;
receive information regarding the network device;
generate the device serial number, wherein the device serial number has a server identification portion, a device information portion, and a random number;
determine that the device serial number has not been issued previously; and
issue the device serial number.

15. The non-transient computer readable medium of claim 14, wherein the network device is a gateway device of a WPAN.

16. The non-transient computer readable medium of claim 14, wherein said information regarding the network device comprises manufacturer information, equipment type, and product generation.

17. The non-transient computer readable medium of claim 14, wherein the server identification portion comprises a server ID which uniquely identities the server.

18. The non-transient computer readable medium of claim 14, wherein execution by the processor further causes the processor to store the device serial number in a data repository.

19. The non-transient computer readable medium of claim 14, wherein execution by the processor further causes the processor to:
receive a connection request from a second network device;
receive the second network device's device serial number;
determine that the second network device's device serial number was not one previously issued by the cloud server; and
deny the connection request.

20. The non-transient computer readable medium of claim 19, wherein the connection request is one of a registration request and login request.
